(19) United States
(12) Patent Application Publication
(10) Pub. No.: US 2015/0114833 A1
(43) Pub. Date: Apr. 30, 2015

(54) PREHEATING CONNECTOR

(71) Applicant: RIO TINTO ALCAN INTERNATIONAL LIMITED, Montréal (CA)

(72) Inventor: Pierre Bon, Saint Jean de Maurienne (FR)

(73) Assignee: RIO TINTO ALCAN INTERNATIONAL LIMITED, Montréal, QC (CA)

(21) Appl. No.: 14/391,916

(22) PCT Filed: Apr. 12, 2013
(86) PCT No.: PCT/CA2013/050288

§ 371 Date: Oct. 10, 2014

(30) Foreign Application Priority Data
Apr. 24, 2012 (FR) 12/01193

(51) Int. Cl. C25C 3/12; C25C 3/06; C25C 7/02; H01R 43/26

(52) U.S. Cl. CPC C25C 3/12; H01R 43/26; C25C 3/06; C25C 7/025
USPC 204/274; 29/825; 204/286.1

(57) ABSTRACT

This preheating connector for electrically connecting an anode stern to an anode frame of an electrolytic cell during the warm-up phase of the electrolytic cell, includes means of fixing to the anode frame, and bearing means designed to exert pressure on the anode stem in order to keep it pressed up against the anode frame, the fixing means and bearing means being configured and arranged so as to add on the preheating connector onto a so-called permanent connector for electrical and mechanical connection of the anode stem to the anode frame during the continuous operating mode of the cell.

The present invention relates to a preheating connector for electrically connecting an anode stem to an anode frame of an electrolytic cell during its warm-up phase, an electrolytic cell equipped with this preheating connector, and a method for electrically connecting the anode stems to the anode frame of an electrolytic cell to preheat the electrolytic cell.

Conventionally, aluminum is produced industrially by electrolysis of alumina dissolved in a molten cryolite bath using the Hall-Heroult method in electrolytic cells. An electrolytic cell typically comprises a metal box with a refractory lining. A cathode made of carbonaceous material is placed at the bottom of the box.

In continuous operation mode, during which the aluminum is produced, the cathode is covered with a layer of liquid aluminum and an electrolytic bath, and anodes made of carbonaceous material are partially immersed in the electrolytic bath. Each anode is fixed to one end of an anode stem. The anode stems are connected to an anode frame via electrical and mechanical connection systems also called connectors. In the following, these connectors for electrical and mechanical connection of anode stems to the anode frame during continuous operation mode of the cell will be designated as permanent connectors.

The anode frame is integral with a superstructure supported by concrete legs resting on the box and acting as electrical insulation between the box and the superstructure. Conventionally, the anode frame is movable relative to the superstructure in order to adjust the position of the anodes, which are consumed in the electrolysis bath as the electrolysis reaction proceeds.

Conventionally, the continuous operating mode of an electrolytic cell is preceded by phase in which the cell is preheated, designed to bring it from an initially cold state to an operating temperature of about 960° C. By virtue of the progressive rise in temperature that it brings about, this preheating phase makes it possible to avoid thermal shock to the cathode which would reduce the life of the cell.

It is known, particularly from patent U.S. Pat. No. 7,485,215, that this phase of preheating the cathode can be achieved by placing on the cell a layer of a carbonaceous material designed to heat the cell by electrical resistance (Joule effect) when the current passes through the electrolysis cell. So unlike when in the continuous operating mode, the electrolytic cell when warming up does not contain a liquid electrolytic bath and the anodes are not suspended from the superstructure but rest on the layer of carbonaceous material.

To properly route the electrolysis current during the cell preheating phase, provision is made to provide a high quality electrical contact between the anode frame and each anode stem. A poor contact between the anode frame and the anode stems may lead to an increased voltage drop, creating electric arcs that are dangerous for operators and likely to damage the contact surfaces, or it may cause the electrolysis current to deflect into unsuitable elements placed nearby and therefore likely to melt.

In addition, the expansion of the cathode, the cell, the superstructure, the anodes and anode stems, due to their gradual temperature increase, must be taken into account so that this expansion does not cause harmful mechanical stresses to the electrolysis cell. Failure to adequately take this expansion, and therefore the relative movements induced on the components of the cell, into account may result in the transmission of mechanical stress to the feet supporting the concrete superstructure causing them to break.

The use, during the warm-up phase, of systems for electrically connecting an anode stem to the anode frame is known; these systems are hereinafter referred to as preheating connectors, providing a high-quality electrical contact between the anode stem and the anode frame and allowing movement of the anode stem relative to the anode frame to accommodate the expansion thereof.

However, existing preheating connectors must be removed as soon as preheating has ended to allow the permanent connectors suitable for the continuous operating mode of the cell to be fitted. In addition to the time wasted in removing the preheating connectors and successively fitting permanent connectors, this may result in damage to the quality of the contact between the anode stem and the anode frame. Once the preheating connectors have been removed, and as long as the permanent connectors have not yet been positioned and tightened, the quality of the electrical connection between the anode stem and the anode frame is not fully guaranteed.

In addition, most existing preheating connectors prove difficult to handle because of their size, mass and the strong magnetic fields surrounding the electrolytic cells. So fitting and withdrawing them (at least one preheating connector per anode stem in the cell) to perform the preheating phase is relatively time-consuming, dangerous and involves a large number of operators, who must in addition be assisted by special, expensive equipment to handle these preheating connectors.

The number of operators present during preheating connector fitting or withdrawal operations, the duration of these operations, the equipment required, placed on the floor when not in use, and the difficult environment in which these operations are carried out make the operators' task difficult and tedious.

Finally, known preheating connectors often require much expensive maintenance to keep them functioning properly.

From patent document GB2111082A, a connector doing duty as both permanent connector and preheating connector is also known. In addition to these connectors, there are also frame-lifting connectors that allow lifting the anode frame after immobilizing the anode stems using frame-lifting connectors and disconnecting the connectors. These frame-lifting connectors are used to immobilize the anode against a stationary part of the superstructure that conducts the electrolysis current for a short period of time and they cannot be used as preheating connectors allowing movement of the anodes. The GB2111082A device is, however, not economically viable and far too complicated to use and maintain.

The present invention therefore aims to alleviate some or all of these drawbacks by proposing a preheating connector that is easy to handle and maintain, reducing the risk of deterioration in the quality of the contact between an anode stem and an anode frame, including during transition between the preheating phase and the beginning of the continuous operating mode of the electrolytic cell.

To this end, the present invention relates to a preheating connector for electrically connecting an anode stem to an anode frame of an electrolytic cell during the warm-up phase of the electrolytic cell, characterized in that the preheating connector includes means of fixing to the anode frame, and bearing means designed to exert pressure on the anode stem in order to keep it pressed up against the anode frame, the fixing means and bearing means being configured and arranged so as to add on the preheating connector onto a so-called permanent connector for electrical and mechanical connection of the anode stem to the anode frame during continuous operating mode of the cell.

The preheating connector according to the invention therefore offers the capability of being fitted and used while a permanent connector is already present, i.e. of coexisting with a permanent connector. With the preheating connector according to the invention, it is therefore possible to prepare the continuous operation mode of the cell (once preheating has ended) by actuating the permanent connectors without previously removing the preheating connectors. This results in a high-quality electrical contact being maintained during the transition period between the end of the preheating phase and the start of the continuous operation mode of the cell.

According to a feature of the preheating connector according to the invention, the fixing means and bearing means are configured and arranged so as to superpose the preheating connector onto the permanent connector.

Advantageously, the fixing means include a hook.

According to another feature of the preheating connector according to the invention, the bearing means include two levers hinged about an axle and means for connecting and tightening levers, each lever supporting at least one bearing surface designed to bear against the anode stem.

In this way, the preheating connector according to the invention offers the advantage of a structure that is simple to maintain and handle.

According to one possibility, each bearing surface corresponds to a wall of a rotating roller.

This characteristic has the advantage of allowing a translation movement of the anode stem relative to the anode frame to compensate for the expansion of the cell components, while allowing the anode stem to remain pressed up against the anode frame. Advantageously, this rotating roller is designed to be made from an electrically insulating, heat-resistant material with a low friction coefficient.

According to one embodiment, the levers each include two flanges spaced a predetermined distance apart from each other by at least one crosspiece.

The flanges of a lever in this way define a space designed to receive the permanent connector.

Advantageously, the crosspiece(s) support(s) (one of) the bearing surfaces.

According to one embodiment, the connecting and tightening means of the levers include two jaws each designed to be assembled to one of the levers, and a threaded rod which connects the two jaws.

Preferably, the jaws each include two grooves and the levers each include two end hooks, the end hooks and the jaw grooves working in conjunction in a complementary manner to assemble the jaws to the levers.

According to a feature of the preheating connector according to the invention, the latter includes means for visual identification of the two levers.

Advantageously, at least one of the flanges includes at least one perforation.

The perforations reduce the weight of the levers while maintaining stiffness and strength.

According to another aspect of the present invention, the latter also relates to an electrolytic cell for the production of aluminum by electrolysis, comprising an anode stem and an anode frame, characterized in that it includes simultaneously one so-called permanent connector for electrical and mechanical connection of the anode stem with the anode frame in continuous operating mode and a preheating connector for electrical connection of the anode stem with the anode frame during the warm-up phase of the electrolytic cell.

According to one embodiment, the preheating connector is superposed on the permanent connector.

Advantageously, the permanent connector includes an axle supported by the anode frame and the preheating connector is attached to the axle of the permanent connector.

According to one embodiment, an electrically insulating strip is interposed between a bearing surface of the preheating connector and the anode stem.

This provides the advantage of preventing electric current from passing through the preheating connector.

According to yet another aspect of the present invention, it is also a method of electrically connecting an anode stem to the anode frame of an electrolytic cell in order to preheat the electrolytic cell, characterized in that it includes a step in which a preheating connector is fitted, to electrically connect the anode stem to the anode frame during the warm-up phase of the electrolytic cell, in addition to a so-called permanent connector for the electrical and mechanical connection of the anode stem to the anode frame in continuous operation mode.

According to one characteristic of the method according to the invention, the step in which the preheating connector is fitted is preceded by a step in which an electrically insulating strip is fitted against the anode stem.

According to one characteristic of the method according to the invention, the step in which the preheating connector according to the invention is fitted includes superposing the preheating connector onto the permanent connector.

According to yet another characteristic of the method according to the invention, the step in which the preheating connector is fitted includes the following steps:
fixing a first lever to an axle of the permanent connector, and a second lever to the axle of the permanent connector
assembling a first jaw onto the first lever and a second jaw onto the second lever,
tightening the first lever and the second lever by rotating a threaded rod connecting the first jaw and the second jaw.

In this way, tightening the levers by means of the jaws causes the rotation thereof relative to the axle on which they are articulated, so that the end of the levers opposite to that receiving the jaws moves towards the anode frame. This presses the anode stem up against the anode frame.

Advantageously, the step in which the preheating connector is fitted includes a prior step to identify the first lever via visual identification means.

This prevents an operator in charge of fitting the preheating connectors from wasting time by choosing the wrong lever to be first fixed to the axle of the permanent connector.

Other features and advantages of the present invention will become apparent from the following description of an embodiment of the invention, given as a non-restrictive example, with reference to the accompanying drawings in which:

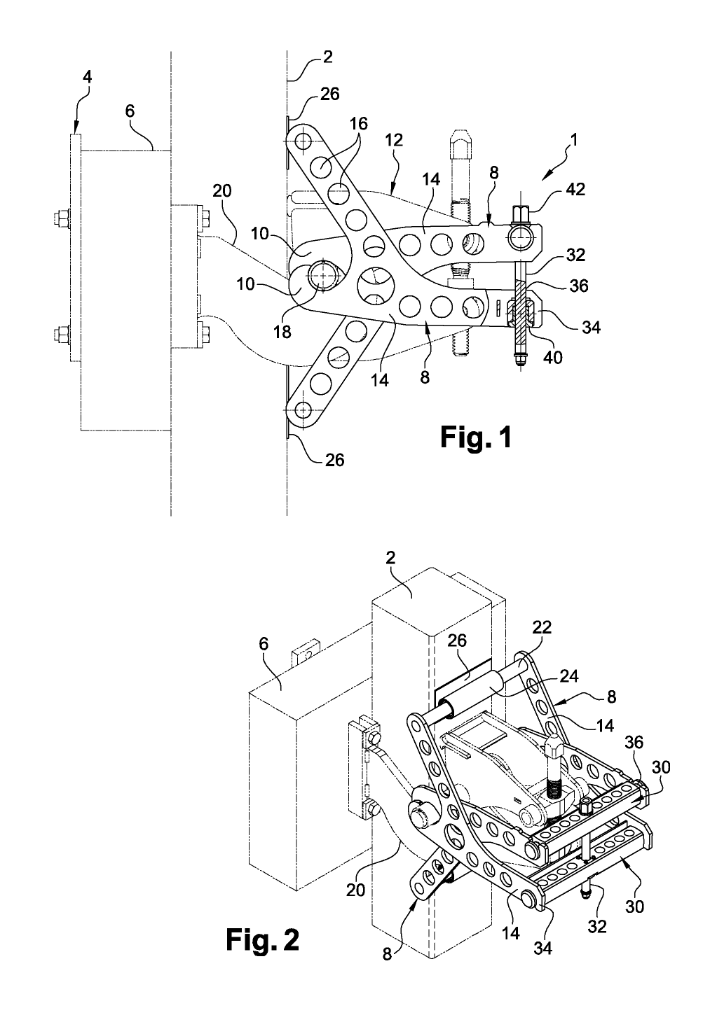

FIG. 1 is a side view of a preheating connector according to one embodiment of the invention,

FIG. 2 is a perspective view of a preheating connector according to one embodiment of the invention,

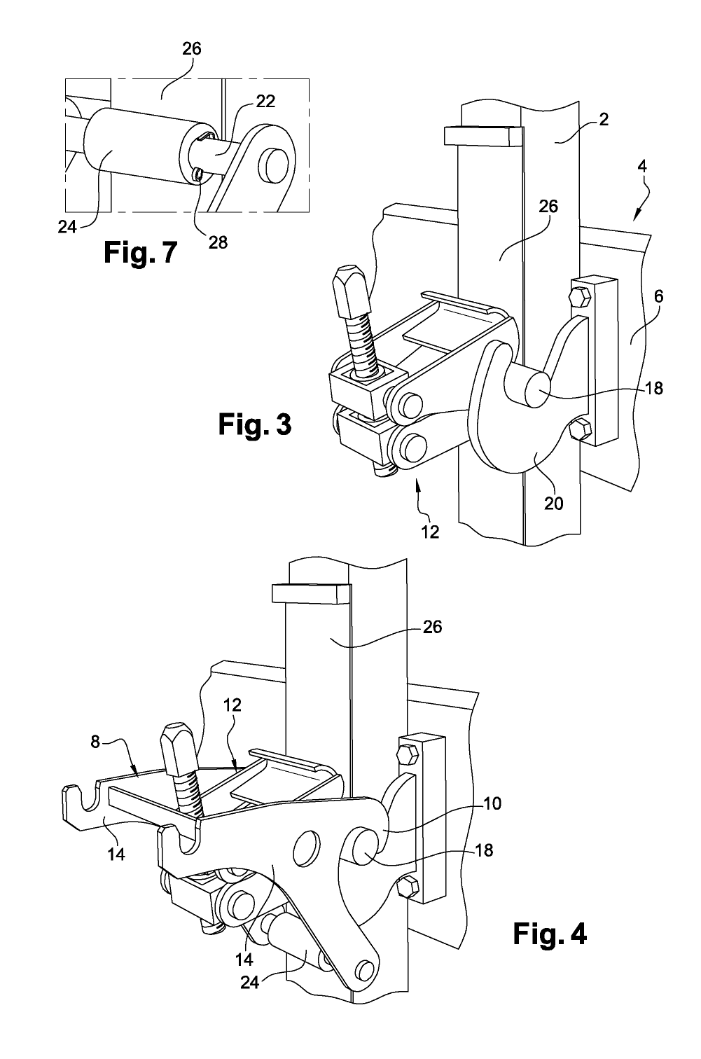

FIGS. 3-6 are perspective views of an electrolytic cell according to one embodiment of the invention, illustrating various steps of the method for electrical connection of the anode stems to the anode frames of the electrolytic cell,

FIG. 7 is a perspective view of a part of preheating connector according to one embodiment of the invention,

FIGS. 1 and 2 show a preheating connector 1 according to an embodiment of the invention.

The preheating connector 1 is suitable for electrically connecting an anode stem 2 of an electrolytic cell 4 (only part of which is shown in the figures) to an anode frame 6 of the electrolytic cell 4 during the warm-up phase of the electrolytic cell 4.

The preheating connector 1 includes means for bearing, such as levers 8, designed to exert pressure on anode stem 2 to keep it pressed up against the anode frame 6.

The preheating connector 1 also includes means for fixing it to the anode frame 6, such as hooks 10.

The levers 8 and the hooks 10 are arranged and configured to allow for attachment of the preheating connector 1 to the anode frame 6 in addition to a permanent connector 12. According to the embodiment shown in FIGS. 1 to 6, levers 8 and hooks 10 are arranged and configured to allow the preheating connector 1 to be superposed onto the permanent connector 12. In other words, the preheating connectors 1 can be placed on top of the 12 permanent connectors.

Levers 8 are each formed by two flanges 14 spaced a predetermined distance apart from each other enabling the preheating connector 1 to be superposed onto the permanent connector 12. The space defined between each of the flanges 14 is in this way suitable for holding the permanent connector 12.

In the embodiment shown in FIGS. 1 and 2, each flange 14 includes a plurality of perforations 16 to lighten the levers 8 while maintaining stiffness and strength.

For example, the preheating connectors 1 according to the invention, designed for anodes weighing nearly 1.5 tonnes are made of aluminum alloy and have a mass of less than 21 kg, each lever 8 weighing less than 7 kg.

Each flange 14 includes one of the two hooks 10 fitted to each lever 8. The hooks 10 therefore form an integral part of the levers 8. In other words, hooks 10 and levers 8 form a single part.

The hooks 10 are designed to work in tandem with an axle 18 around which levers 8 are articulated. Axle 18 corresponds here to an axle belonging to permanent connector 12 onto which preheating connector 1 is superposed.

Axle 18 is here supported by hooks 20 interdependent of anode frame 6.

Flanges 14 are connected to each other by at least one crosspiece 22. Crosspieces 22 maintain the gap between flanges 14.

The two levers 8 of preheating connector 1 are substantially similar in structure. It should, however, be noted that one of the two levers 8 is configured so as to be inserted between the flanges 14 of the other lever 8. In other words, the space between the flanges 14 of one of the levers 8 is adapted to receive and contain the other lever 8.

Levers 8 each include a bearing surface, corresponding here to the outer wall of a rotating roller 24, arranged at a first end of levers 8. Each bearing surface is adapted so as to come to bear against an electrically insulating strip 26, for example corresponding to a pressboard, placed on the anode stem 2. Advantageously, this rotating roller 24 is made from a heat-resistant material with a low friction coefficient. As can be seen in FIGS. 1 and 2, the electrically insulating strips 26 are of similar width to that of the face of the anode stem 2 on which they rest. Here there are two of them, one for the bearing surface of each lever 8. According to an alternative, no use is made of an electrically insulating strip but the rotating roller is designed to be made from an electrically insulating material. Each lever 8 here includes a rotary roller 24. The rotating rollers 24 are pivotally mounted on the crosspieces 22.

According to the embodiment shown in FIG. 7, the rotating rollers 24 can be held in position by a pin 28. The pins 28 are inserted, for example, into a hole made in one of the crosspieces 22. One end of the pin 28 is bent so as to remain in position in the hole of the crosspiece 22, to prevent the rotary roller 24 from moving sideways along the crosspiece 22.

The preheating connector 1 also includes means for connecting and tightening the two levers 8, for example two jaws 30 working in tandem with a threaded rod 32.

According to the embodiment illustrated in FIGS. 1 and 2, the flanges 14 of each lever 8 include a second end opposite the first end relative to the axle 18 of the levers 8, in the shape of a hook 34.

Each jaw 30 includes two grooves 36: the grooves 36 are configured to receive the second ends of the flanges 14 in the shape of a hook 34. In this way, the jaw 30 can be assembled onto levers 8.

The jaws 30 contain a bore 36 designed to receive the threaded rod 32. One of these bores 36 is threaded; in the example shown in FIG. 2, the bore includes a threaded insert 40. The threaded rod 32 includes a bearing surface designed to bear against one of the jaws 30, for example an underside of its head 42. The threaded rod 32 can be rotated relative to the jaws 30.

In this way, rotation of the threaded rod 32 causes the jaws 30 to move together, and consequently levers 8 to rotate in relation to axle 18 to which they are attached. The rotary rollers 24 then exert a pressure against the anode stem 2 towards the anode frame 6.

The preheating connector 1 may include means of visual identification designed to enable the two levers 8 to be distinguished from one another. An operator can therefore easily identify the lever 8 which it is advantageous to place or remove first. The means of visual identification may include a foolproofing lug integral with one of the flanges 14 of one of the two levers 8 only, or may correspond to a color code assigned to the levers 8.

The invention also relates to an electrolytic cell 4, partially shown in FIGS. 3 to 6, comprising simultaneously for one anode stem 2 a permanent connector 12 and a preheating connector 1.

The preheating connector 1 is advantageously superposed on the permanent connector 12. Levers 8 are fixed to the axle 18 of permanent connector 12.

FIGS. 3-6 also illustrate successive steps in a method for electrically connecting the anode stems 2 to 6 to the anode frames of the electrolytic cell 4 for preheating cell 4, according to another aspect of the present invention.

The method includes a step in which a preheating connector 1 is fitted, in addition to the permanent connector 12.

Fitting the preheating connector 1 may consist of superposing preheating connector 1 onto permanent connector 12.

The method may include a step in which permanent connectors 12 are fitted (one for each anode stem 2), when they are not already fitted. This step is illustrated in FIG. 3. More specifically, this step may include positioning of each end of the axle 18 of each permanent connector 12 into a hook 20 attached to the anode frame 6. The permanent connectors 12 are thereby suspended from the anode frame 6.

The method includes a step in which a first lever 8 is positioned, illustrated in FIG. 4. The first lever 8 may have been identified by an operator via the means of visual identification mentioned above.

This is lever 8 designed to fit inside the space defined between flanges 14 of the second lever 8 of preheating connector 1.

The step in which the first lever 8 is positioned specifically involves fixing the first lever 8 onto the axle 18 of the permanent connector 12 by means of hooks 10. The first lever 8 is suspended from the axle 18. According to the embodiment shown in FIGS. 3-6, the first lever 8 is superposed onto the permanent connector 12.

The step in which the first lever 8 is positioned, and optionally the step in which the permanent connector 12 is fitted is advantageously preceded by a step in which an electrically insulating strip 26 is fitted. The electrically insulating 26 strip is placed on the face of the anode stem 2 against which the rotary roller 24 of each lever 8 is designed to bear.

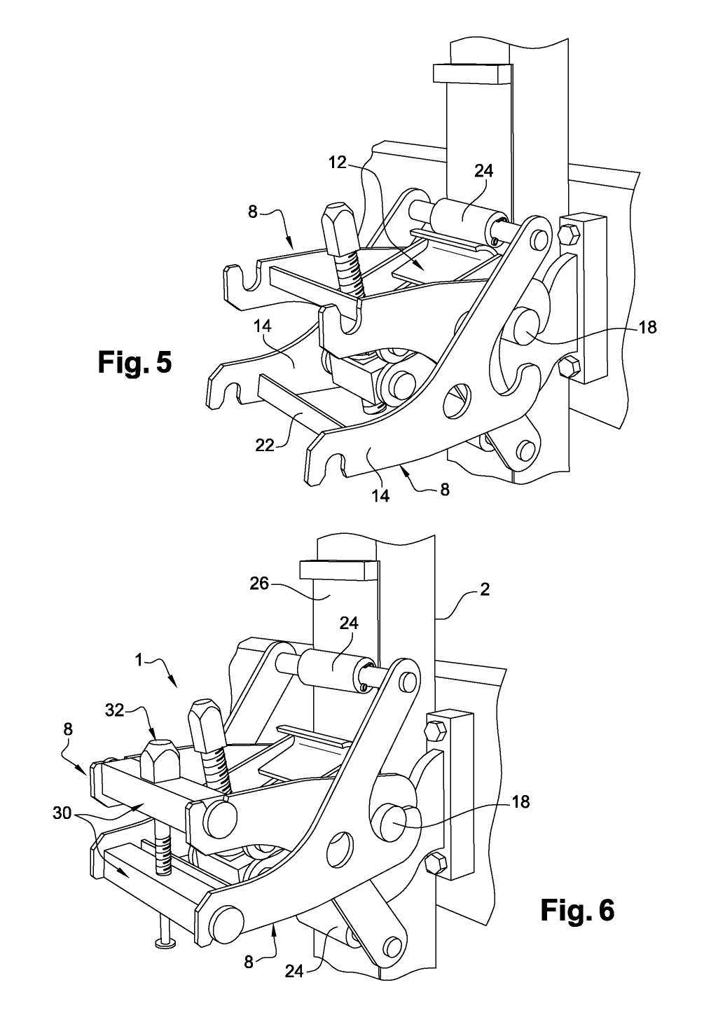

The method then includes a step in which the second lever 8, shown in FIG. 5, is fitted. This step consists here in superposing the second lever 8 on the permanent connector 12 and on the first lever 8, which are thereby placed in the space defined between the flanges 14 of the second lever 8.

As shown in FIG. 6, the method then includes the step in which the first lever 8 and the second lever 8 are connected and tightened.

This step involves placing a jaw 30 onto the first lever 8, a jaw 30 onto the second lever 8, then inserting a threaded rod 32 connecting the two jaws 30 if this is not already the case. All that is then necessary is for an operator to ensure that the first lever 8 and the second lever 8 are properly articulated around the axle 18 to which they have been fixed, and then screw the threaded rod 32 to cause the jaws 30 to move towards each other, and therefore the levers 8 to rotate about the axis 18 and the rotary rollers 24 to bear against the anode stem 2 via the electrically insulating strip 26.

During preheating of the electrolytic cell 4, the permanent connectors 12 are loosened: they do not contribute to the electrical connection of the anode stems 2 to the anode frame 6 supporting them. At most, the permanent connectors 12 play a supporting role with regard to the preheating connectors 1 when these are fixed to the axle of the permanent connectors 12.

At the end of the preheating phase, the permanent connectors 12 are tightened so as to electrically and mechanically connect the anode stems 2 and the anode frame 6 (the anode stems 2 are immobilized and become interdependent with the anode frame 6 supporting them). The preheating connectors 1 are then loosened (by rotating the threaded rod 32 in the opposite direction).

In this way, the quality of the electrical contact is maintained during the transition between the preheating phase and the continuous operating mode. In addition, this transition is a quick one since it does not require the preheating connectors 1 to be removed and the permanent connectors 12 to be then fitted.

During the continuous operating mode, the preheating connectors 1 can be removed (without any special tools in view of their geometry and mass), or be left in position, loosened.

Naturally, the invention is in no way limited to the embodiment described above, as this embodiment is provided only as an example. Changes remain possible, particularly from the point of view of the constitution of the various components or substitution by technical equivalents without going beyond the scope of protection of the invention.

The preheating connector 1 articulation axle 18 does not necessarily correspond to an axle on a permanent connector 12, but can be a separate axle attached to the electrolytic cell 4.

The jaws 30 may also be an integral part of each lever 8, the ends of the jaws being interdependent with one or other of the flanges 14 of each lever 8.

1. Preheating connector for electrically connecting an anode stem to an anode frame of an electrolytic cell during the warm-up phase of the electrolytic cell, characterized in that the preheating connector includes means of fixing to the anode frame, and bearing means designed to exert pressure on the anode stem in order to keep the anode stem pressed up against the anode frame, the fixing means and bearing means being configured and arranged so as to add on the preheating connector onto a permanent connector for electrical and mechanical connection of the anode stem to the anode frame during a continuous operating mode of the cell.

2. Preheating connector according to claim 1, characterized in that the fixing means and bearing means are configured and arranged to superpose the preheating connector onto the permanent connector.

3. Preheating connector according to claim 1, characterized in that the fixing means include a hook.

4. Preheating connector according to claim 1, characterized in that the bearing means include two levers hinged about an axle and means for connecting and tightening levers, each lever supporting at least one bearing surface designed to bear against the anode stem.

5. Preheating connector according to claim 4, characterized in that each bearing surface is a wall of a rotary roller.

6. Preheating connector according to claim 4, characterized in that the levers each include two flanges spaced a predetermined distance apart from each other by at least one crosspiece.

7. Preheating connector according to claim 6, characterized in that the at least one crosspiece support the at least one bearing surface.

8. Preheating connector according to claim 4, characterized in that the connecting and tightening means of the levers include two jaws each designed to be assembled to one of the levers and a threaded rod connecting the two jaws.

9. Preheating connector according to claim 8, characterized in that the jaws each include two grooves and the levers each include two end hooks, the end hooks (34) and grooves of the jaws working in tandem to assemble the jaws to the levers.

10. Preheating connector according to claim 4, characterized in that the preheating connector includes means for visual identification of the two levers.

11. Preheating connector according to claim 6, characterized in that at least one of the flanges includes at least one perforation.

12. Electrolytic cell for the production of aluminum by electrolysis, comprising an anode stem and an anode frame, characterized in that the electrolytic cell simultaneously includes a permanent connector designed for electrical and mechanical connection of the anode stem to the anode frame during continuous operating mode and a preheating connector for electrical connection of the anode stem to the anode frame during preheating of the electrolytic cell.

13. Electrolytic cell according to claim 12, characterized in that the preheating connector is superposed onto the permanent connector.

14. Electrolytic cell according to claim 12, characterized in that the permanent connector includes an axle supported by the anode frame and in that the preheating connector is fixed to the axle of the permanent connector.

15. Electrolytic cell according to claim 12, characterized in that an electrically insulating strip is interposed between a bearing surface of the preheating connector and the anode stem.

16. Method for electrically connecting an anode stem to an anode frame of an electrolytic cell to preheat the electrolytic cell, characterized in that the method comprises fitting a preheating connector for electrical connection of the anode stem to the anode frame during the preheating phase of the electrolytic cell, in addition to a permanent connector for electrical and mechanical connection of the anode stem to the anode frame in a continuous operating mode.

17. Method according to claim 16, characterized in that fitting the preheating connector is preceded by fitting an electrically insulating strip against the anode stem.

18. Method according to claim 16, characterized in that fitting the preheating connector includes the superposition of the preheating connector onto the permanent connector.

19. Method according to claim 16, characterized in that fitting the preheating connector includes:
fixing a first lever to an axle of the permanent connector, and a second lever to the axle of the permanent connector,
assembling a first jaw onto the first lever and a second jaw onto the second lever, and
tightening the first lever and the second lever by rotating a threaded rod connecting the first jaw and the second jaw.

20. Method according to claim 19, characterized in that fitting the preheating connector includes a prior step of identifying the first lever via visual identification means.
